(19) United States
(12) Patent Application Publication
(10) Pub. No.: US 2005/0095320 A1
(43) Pub. Date: May 5, 2005

(54) [An Isotonic Sports Drink for Female Athletes Fortified with Iron, Calcium and Essential Vitamins for Use in Rehydration and Nutrition During Execise and Competition]

(75) Inventors: Richard L. Botteri, Mt. Bethel, PA (US); Megan K. Botteri, Mt. Bethel, PA (US)

Correspondence Address: RICHARD L. BOTTERI, 193 ORCHARD ROAD, MT. BETHEL, PA, 18343, US

(73) Assignees: Richard L. Botteri, Mt. Bethel, PA (US); Megan K Botteri, Mt. Bethel, PA (US)

(21) Appl. No.: 10/605,816

(22) Filed: Oct. 29, 2003

(51) Int. Cl. A23L 1/30

(52) U.S. Cl. 426/72

(57) ABSTRACT

The present invention provides an isotonic sports drink composition that can be administered orally to provide electrolytes and energy lost during physical exertion as well as provide essential vitamins and minerals to female and teenage athletes who are at risk of Iron Deficiency Anemia, Amenorrhea, Hypocalceremia and Osteoporosis.

### BACKGROUND OF INVENTION

The invention is an isotonic sports drink and sports drink concentrate for women and teenage athletes, fortified with solubilized Calcium, Iron, Vitamin C, Vitamin D and Prebiotic Fiber, useful in providing an energy source and rehydrating and regaining electrolytic balance before, during and after periods physical exertion and exercise as well providing essential vitamins and minerals to female and teenage athletes who are at risk of Iron Deficiency Anemia, Amenorrhea, Hypocalceremia and Osteoporosis.

### SUMMARY OF INVENTION

The beverage is an isotonic sports drink and sports drink concentrate that is useful in providing an energy source and rehydrating and regaining electrolytic balance lost during periods of physical exertion and exercise as well as providing essential vitamins and minerals to female and teenage athletes who are at risk of Iron Deficiency Anemia, Amenorrhea, Hypocalceremia and Osteoporosis.

### DETAILED DESCRIPTION

The invention is an isotonic sports drink and sports drink concentrate for women and teenage athletes, fortified with solubilized Calcium, Iron, Vitamin C, Vitamin D and Prebiotic Fiber, useful in providing an energy source and rehydrating and regaining electrolytic balance before, during and after periods physical exertion and exercise as well providing essential vitamins and minerals to female and teenage athletes who are at risk of Iron Deficiency Anemia, Amenorrhea, Hypocalceremia and Osteoporosis

Said beverage comprises: purified water; carbohydrates (glucose, high fructose corn syrup or fructose corn syrup solids); and contains small amounts of salt; potassium chloride; calcium gluconate (calcium); ferric pyrophosphate, polyglycerol esthers, lecithin (iron); Vitamin B Complex (B1 (thiamin), B2 (riboflavin), niacin (nicotinic acid), B6 (pyridine), B12 (cyanocobalamin), folic acid, pantothenic acid, and biotin (helps the body convert carbohydrates into energy), ascorbic acid (vitamin C—promotes iron absorption); cholecalciferol (vitamin D₃ promotes calcium absorption); prebiotic fiber (oligofructose, fructose, sprouted mung bean extract and acesulfame K—promotes vitamin B production and calcium absorption); natural and artificial flavors; and potassium sorbate (preserves freshness).

Since the presently claimed invention contains a number of different ingredients, it is important to understand the part played by each ingredient. Each of the important ingredients are explained herein.

Water—Water is the most important ingredient in the invention and in a sports beverage. Water serves to help replace lost fluids within the body and serves as a carrier for the carbohydrates and minerals necessary to aid the effectiveness of the beverage. Water also aids in regulating one's internal body temperature.

Water in the invention also solubalizes the ingredients during manufacture

Water is present in the claimed invention at a total concentration of 93.5% weight percent.

Carbohydrates

Carbohydrates are present in the beverage of the invention as an energy source. In a preferred isotonic beverage, sugars such as glucose and high fructose corn syrup solids or liquids with a dextrose equivalent (DE) value of 42 are used as the carbohydrate in the invention.

It should be noted that the carbohydrates used in the invention are present at a particular concentration in the beverage. While carbohydrates are necessary and beneficial as an energy source, absorption in the small intestine is slowed if the carbohydrate concentration is too high. Preferably the carbohydrate source for athletic competition is present at a total concentration of 6 to 8% weight percent. Consequently, this is the approximate concentration of carbohydrate present in the presently claimed beverage.

Electrolytes Several electrolytes are present in the isotonic beverage to help replenish the minerals lost through sweat. These include sodium chloride, sodium benzoate, potassium chloride, and potassium sorbate. It should be noted that the sodium content helps stimulate people to drink more fluid voluntarily. This gives an advantage over water since voluntary consumption helps encourage a person to drink enough fluids to be adequately rehydrated. It is important to remember that thirst alone is a poor indicator of fluid needs. The human body becomes partially dehydrated even before any sense of thirst felt. Sodium also helps a person maintain body fluids whereas consuming plain water can actually trigger water loss by increasing urine production. Vitamins and Minerals Calcium—Essential for developing and maintaining healthy bones and teeth. Assists in blood clotting, muscle contraction, nerve transmission. Reduces risk of osteoporosis.

Iron—Needed for red blood cell formation and function.

Vitamin B Complex Thiamin (B₁)—Essential for converting carbohydrates to energy. Needed for normal functioning of the nervous system and muscles, including heart muscle.

Riboflavin (B₂)—Helps in red blood cell formation, nervous system functioning and release of energy from foods. Needed for vision and may help protect against cataracts.

Niacin—Promotes release of energy from foods and proper nervous system functioning.

Pyridoxine (B₆)—Essential for protein metabolism, nervous system and immune function. Involved in synthesis of hormones and red blood cells.

Folic acid—Needed for normal growth and development and red blood cell formation. Reduced risk of neural tube birth defects. May reduce risk of heart disease.

Vitamin B₁₂—Vital for blood formation and healthy nervous system.

Vitamin C—Ascorbic Acid. Promotes healthy cell development, wound healing, resistance to infection. Serves as an antioxidant and promotes iron absorption.

Vitamin D—Aids in absorption of calcium, helps build bone mass and prevent bone loss. Helps maintain blood levels of calcium, phosphorus.

Prebiotic Fiber (Oligofructose, Fructose, Sprouted Mung Bean Extract and Acesulfame K) Soluble oligofructose is a non-digestible fiber that becomes a prebiotic, selective food source, to the “beneficial bacteria” (particularly Bifidobacteria and lactobacillus) of the large intestine. This supplementation helps provide B vitamins and helps in the improved absorption of calcium.

Citric Acid—Citric acid is present for several reasons. First, it provides tartness to help balance the sweet taste resulting from the carbohydrates which may comprise high fructose corn syrup solids. It also helps give a clean mouth feel and also lowers the pH of the product, which aids in safe processing. Natural and Artificial Flavors—A variety of natural and artificial flavors are used in order to improve the flavor of the isotonic beverage, and also help to encourage fluid intake.

Preservatives A small amount of sodium benzoate and potassium sorbate are used to preserve freshness.

Preferred Embodiments—One possible embodiment of the invention is created by adding purified water and natural and/or artificial flavorings to the dry ingredients listed below to create a finished sports drink concentrate or beverage. These dry ingredients constitutes Example #1.

### EXAMPLE #1

### Ingredient Weight Percent

Glucose 57.28%, High Fructose Corn Syrup or Corn Syrup Solids 28.2%, Calcium Lactate Gluconate (Calcium) 10.86%, ferric pyrophosphate, polyglycerol esthers, lecithin (iron) 0.08%, Vitamin B Complex 0.04%, Ascorbic Acid (Vitamin C) 0.37%, cholecalciferol (vitamin D₃) 0.00012%, Prebiotic Fiber—Oligofructose, Fructose, Sprouted Mung Bean Extract and Acesulfame K 0.76%, Citric Acid 1.35%,

Another possible embodiment involves Example #2 which is created by adding purified water and natural and/or artificial flavorings to the dry ingredients listed below to create a premix concentrate containing no carbohydrates that is remixed with water and a carbohydrate source to create a full strength beverage.

### EXAMPLE #2

### Ingredient Weight Percent Calcium Lactate Gluconate

(Calcium) 75.75%, ferric pyrophosphate, polyglycerol esthers, lecithin (iron) 0.53%, Vitamin B Complex 0.25%, Ascorbic Acid (Vitamin C) 2.52%, Cholecalciferol (vitamin D₃) 0.00084%, Prebiotic Fiber—Oligofructose, Fructose, Sprouted Mung Bean Extract and Acesulfame K 5.25%, Citric Acid 9.29%,

### Method of Manufacture

In both examples, the dry ingredients are solubilized with water and mixed with a homo-mixer at >10 m/s, homogenized at >15 mPs and pasteurized at 165° F. for 10 seconds.

The invention can be provided in either presweetened concentrate or a premix concentrate base containing no carbohydrates. In the presweetened concentrate form it is reconstituted by admixing 3 oz of the concentrated composition with 16 ounces of water. In the premix form, 1 gallon of premix is admixed with 200 gallons of water and a source of carbohydrates.

### Test Results

A 226 g (8 oz.) sample of the sports drink was tested for content. These results are given below:
Sodium 80 mg, ±0.8 mg
Potassium 32 mg, ±0.5 mg
Calcium 240 mg, ±2.4
Iron 1 mg, ±0.1 mg
Ascorbic Acid—Vitamin C 60 mg, ±0.85 mg
Vitamin D 40 iu,
Oligofructose 0.25 mg, ±0.02 mg
Total Carbohydrate 14 g, ±0.14 g,
Sugars 14 g, ±0.14 g
Protein 0 g.

The invention can be manufactured in either presweetened concentrate or a premix concentrate base containing no carbohydrates. In the presweetened concentrate form it is reconstituted by admixing 3 oz of the concentrated composition with 22 ounces of water. In the premix form, 1 gallon of premix liquid and solids is admixed with 200 gallons of water and a source of carbohydrates.

1. The drink is an isotonic sports beverage and sports beverage concentrate fortified with Calcium, Iron, Vitamin B Complex, Vitamin C, and Vitamin D which is especially useful in providing an energy source as well as essential vitamins and minerals to female and teenage athletes before, during, or after periods of physical activity, who are at risk of Iron Deficiency Anemia, Amenorrhea and Osteoporosis.

2. The drink of claim 1 is an liquid composition adapted for oral administration of water, physiologically essential electrolytes, nutrient vitamins and minerals, and carbohydrates to a human body before, during, or after periods of physical activity.

3. The beverage of claim 1 wherein the carbohydrate source is present at a total concentration in a single serving of 14 grams.

4. The beverage of claim 3 wherein the carbohydrate source comprises glucose.

5. The beverage of claim 3 wherein the carbohydrate source comprises high fructose corn syrup solids.

6. The beverage of claim 1 wherein the electrolyte comprises a group consisting of sodium chloride ions (80 mg) and potassium chloride ions (30 mg) and minor amounts of sodium benzoate, potassium sorbate or potassium phosphate as preservatives.

7. The beverage of claim 1 further comprising a source of Vitamin C wherein said source provides 100 percent of the daily requirement of 60 mg per serving.

8. The beverage of claim 1 further comprising a source of Calcium wherein said source provides 20 percent of the daily requirement of 1200 mg per serving The beverage of claim 1 further comprising a source of Iron wherein said source provides 10% percent of the daily requirement of 15-18 mg per serving The beverage of claim 1 further comprising a source of Vitamin B Complex wherein said source provides 10 percent of the daily requirement of 60 mg per serving.

9. The beverage of claim 1 further comprising a source of Vitamin D wherein said source provides 10 percent of the daily requirement of 200 iu per serving.

10. The beverage of claim 1 further comprising a source of prebiotic fiber as soluble oligofructose that becomes a selective food source in the large intestine

11. The beverage of claim 1 further comprising natural and artificial flavors and artificial or natural color

12. The concentrate of claim 1 wherein said concentrate is in the form of a syrup suitable for constituting with water to form a final beverage for oral administration of water, physiologically essential electrolytes, nutrient minerals, and carbohydrates to a human body.

13. The concentrate of claim 1 wherein said concentrate is in the form of premix concentrate suitable for constituting with water and carbohydrate sources to form a final beverage for oral administration of water, physiologically essential electrolytes, nutrient minerals, and carbohydrates to a human body.
